(19) United States
(12) Patent Application Publication
(10) Pub. No.: US 2013/0206430 A1
(43) Pub. Date: Aug. 15, 2013

(54) FIRE FIGHTING BUCKET FOR AIRCRAFT

(71) Applicant: Shilan Zheng, Richmond (CA)

(72) Inventor: Shilan Zheng, Richmond (CA)

(21) Appl. No.: 13/764,288

(22) Filed: Feb. 11, 2013

Related U.S. Application Data
(60) Provisional application No. 61/597,148, filed on Feb. 9, 2012.

(51) Int. Cl. A62C 3/02; B23P 6/00; A62C 31/28

(52) U.S. Cl. CPC A62C 3/0235; A62C 31/28; B23P 6/00
USPC 169/53; 169/34; 29/402.08

(57) ABSTRACT

The present invention provides a collapsible firefighting bucket having purse lines that have a pre-set, fixed functional length, and which are removably installed onto a releasable connector at one end of the line and onto a pair of aligned openings on the valve at the other end of the line. The fixed functional length of the purse lines is generally determined by the size of the bucket for which they are intended to be used, and more specifically by each purse line's intended location on the valve. The releasable connector may be a releasable connector clip which is itself connected to the control mechanism that moves the valve. Each purse line includes a pre-formed end-stop for stopping the end from passing through the grommet, and a pre-formed connector or loop portion for removably connecting to the releasable connector.

### FIELD OF THE INVENTION

The invention relates to helicopter-carried collapsible fire fighting buckets, and to improved the valve control lines, also known as purse lines, for helicopter-carried collapsible fire fighting buckets.

### BACKGROUND OF THE INVENTION

Fire fighting buckets for carrying by helicopter are well known, and typical buckets are disclosed in U.S. Pat. Nos. 4,474,245 and 4,576,237. Improvements to the bucket shown in these patents have been devised over the years, and some of these improvements are shown in U.S. Pat. No. 5,560,429. These patents disclose fire fighting buckets made of pliable fabric material having an open upper end with a rim to facilitate filing from an open body of water, a side wall extending downwardly from the rim, and a bottom cooperating with the side wall and having an opening. A tubular extension made of pliable material extends from an opening in the bottom to a free end formed with a discharge port to serve as a dump valve. The discharge port has an array of grommetted openings extending there-around to receive a plurality of cords so that the tubular extension can be drawn upwardly into the bucket by the cords before the bucket is filled with water. The discharge port has a circumferential sealing lip made of soft and resilient material, which forms two opposite lip portions which are brought into sealing engagement with each other to minimize water leakage from the tubular extension when the dump valve is positioned below the water surface in the bucket. The plurality of cords serve as valve control lines, also known as purse lines, and pass through the aligned openings to draw the sealing lips into engagement with each other when the cords are tightened. Tension in the cords supports the tubular extension, and the extension is drawn upwardly through the bucket to be supported in a position which can be below an upper level of water within the bucket. Weight of water acting on the tubular extension tensions the cords further and ambient pressure of water acting on the sealing lips augments initial sealing generated by tension in the cords.

To dump the water form the bucket, the sleeve is released by rapidly loosening the valve control lines, or purse lines, by a control or trip mechanism, which permits the tubular extension to fall quickly through the opening in the bottom of the bucket. The lip portions are opened under the weight of water, permitting rapid discharge of water with negligible obstruction.

The buckets described in the patents referenced above have been very successful and are made in a wide range of sizes, the upper limit of which is dependent upon the carrying capacity of the helicopter. However, a disadvantage shared by them is that the purse lines are manually arranged and the functional length, or tie length, of each line is manually adjusted as each line is installed by tying knots at various locations along the line. It is important to achieve the proper tie length for each purse line in order that the sealing lips on the valve achieve a good seal when in the closed position. As well, the best valve sealing action is created when the outside purse lines of the valve have a slightly greater tension than the inside lines. However, it is difficult and time consuming to set the proper tie length of each purse line during installation given the difficulty in achieving a knot at a precise position along each purse line and the amount of loosening and re-tying of each knot that must be carried out until each is set at the correct tie length and location. This presents an inconvenience when the installation of the purse lines is carried out during down time of the fire fighting bucket; however, it may present a more significant problem when the installation is carried out during aerial forest fire fighting operations. Accordingly, the inventor herein has identified a need for more efficient apparatus and methods for replacing worn purse lines on the kinds of fire fighting buckets as described in the above referenced patents.

### SUMMARY OF THE INVENTION

The present invention addresses the difficulties and disadvantages of the prior art by providing a firefighting bucket having purse lines that have a pre-set, fixed functional length (or tie length), and which may be removably installed onto a releasable connector (such as a clip) at one end of the purse line and onto a pair of aligned grommets on the valve at the other end. The fixed functional length of the purse lines is generally determined by the size of fire fighting bucket for which they are intended to be used, and more specifically by each purse line's intended location on the valve. The releasable connector may be a releasable connector clip to which one end of the purse lines are removably connected, and which is itself connected to the control mechanism that moves the valve. Each purse line includes a first end, or stop end, that has a pre-formed end-stop for preventing the stop end from passing through the grommet, and a second end, or connector end, which has a pre-formed connector or loop portion for removably connecting to the releasable connector.

Accordingly, in some embodiments the present invention provides a collapsible fire fighting bucket assembly to be suspended from an aircraft comprising: a harness for suspending the bucket from the aircraft; an open bucket body of pliable material having an open upper rim to facilitate filling from an open body of water, a side wall extending downwardly from the rim and a bottom cooperating with the side wall and having an opening; a tubular extension made of pliable material and extending from the opening in the bottom, the tubular extension having a free end formed with a discharge port to serve as a dump valve, the discharge port having a sealing lip of resilient sealing material which forms two opposite lip portions that are brought into sealing engagement with each other for minimizing water leakage from the tubular extension, the tubular extension having a plurality of aligned openings, each opening being associated with a respective lip portion of the sealing lip for bringing the lip portions into sealing engagement; a plurality of tension lines, each having a first end with a pre-formed end stop and a second end with a pre-formed connector portion, each tension line passing from the end stop, through a pair of aligned openings in the lip to the second end; a control mechanism to which the connector portion of the tension lines are releasably connected for moving the tubular extension between a raised position in which the free end thereof extends upwardly from the bottom with the discharge port positioned below a full water level in the bucket and a lowered position in which the free end of the tubular extension extends downwardly from the bottom of the bucket for dumping the water; wherein each tension line has a preset length between the end stop and the connector portion.

In some embodiments, the control mechanism includes a releasable connector clip and the connector portion defines a void through which the connector clip is inserted, thereby achieving the releasable connection between the control mechanism and the tension lines. In some embodiments the connector portion comprises a loop portion at the second end for releasably connecting to the releasable connector clip.

In some embodiments, the preset length of each tension line is based on the location of said tension line on the tubular extension.

In some embodiments, the preset length of the tension lines that are located towards the sides of the tubular extension are shorter than the preset length of the tensions lines that are located towards the centre of the tubular extension such that the outer tension lines are under greater tension than the inner tension lines.

In some embodiments, the tension lines include indicia that varies based on the preset length of the tension lines such that tension lines of the same preset length have common indicia and tension lines of different preset lengths having differing indicia. In some embodiments, the indicia comprises color.

In another aspect the present invention provides, in a fire fighting bucket assembly in which a tubular extension made of pliable material extends from an opening in the bottom of the bucket and has a free end formed with a discharge port to serve as a dump valve, and in which the discharge port has a sealing lip of resilient sealing material which forms two opposite lip portions that are brought into sealing engagement with each other for minimizing water leakage from the tubular extension, and in which the tubular extension has a plurality of aligned openings, each opening being associated with a respective lip portion of the sealing lip for bringing the lip portions into sealing engagement, and in which a plurality of purse lines pass through pairs of aligned openings and are connected to a control mechanism for raising and lowering the tubular extension, an improved valve control system comprising: a releasable connector clip connected to the control mechanism; and plurality of purse lines, each having a first end with a pre-formed end stop for preventing the first end from passing through the opening and a second end having a pre-formed loop portion for connecting onto the releasable connector clip, wherein each purse line has a preset length between the end stop and the loop portion.

In some embodiments, the wherein the preset length of each purse line is based on the location of said purse line on the tubular extension. In some embodiments, the preset length of the purse lines that are located towards the sides of the tubular extension are shorter than the preset length of the purse lines that are located towards the centre of the tubular extension such that the outer purse lines are under greater tension than the inner purse lines.

In some embodiments, purse lines include indicia that varies based on the preset length of the purse lines such that purse lines of the same preset length have common indicia and purse lines of different preset lengths having differing indicia. In some embodiments, the indicia may be color.

In another aspect the present invention provides, in a fire fighting bucket assembly in which a tubular extension made of pliable material extends from an opening in the bottom of the bucket and has a free end formed with a discharge port to serve as a dump valve, and in which the discharge port has a sealing lip of resilient sealing material which forms two opposite lip portions that are brought into sealing engagement with each other for minimizing water leakage from the tubular extension, and in which the tubular extension has a plurality of aligned openings, each opening being associated with a respective lip portion of the sealing lip for bringing the lip portions into sealing engagement, and in which a plurality of purse lines pass through pairs of aligned openings and are connected to a control mechanism for raising and lowering the tubular extension, an improved method of replacing worn purse lines comprising: disconnecting the worn purse lines form the control mechanism and removing the worn purse lines from the aligned openings; providing a releasable connector clip and connecting the clip to the control mechanism; providing a plurality of replacement purse lines, each having a first end with a pre-formed end stop and a second end having a pre-formed loop portion, and each having a preset length between the end stop and the loop portion; threading each purse line through a pair of aligned openings, starting from the second end to the first end until the end stop abuts the opening to prevent the first end from passing through; and connecting the loop portion of each purse line onto the releasable connector clip.

In some embodiments, the purse lines provided vary in their preset length such that the purse lines located towards the sides of the tubular extension are shorter than the purse lines located towards the centre of the tubular extension.

In some embodiment, the loop portions of the purse lines are connected onto the clip member in the same sequence in which the purse lines are located on the tubular member.

DESCRIPTION OF THE DRAWINGS

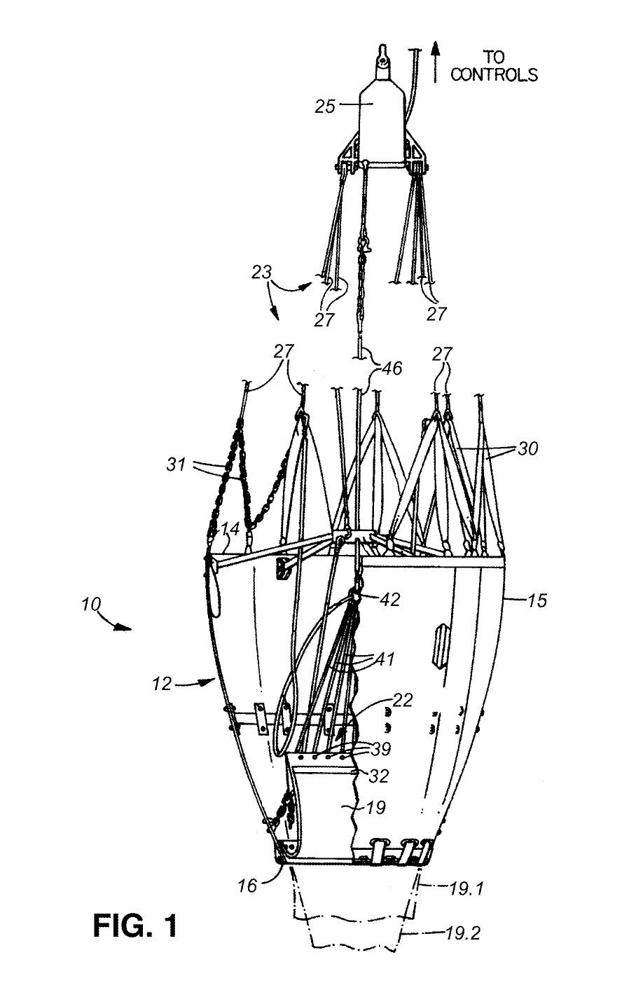

FIG. 1 is a simplified fragmented, partially sectioned side elevation of a collapsible fire fighting bucket as suspended from an aircraft, a portion of the dump valve thereof being shown in a retracted and closed position in full outline, and fragmented in broken outline in an open extended or discharge position, some internal details of the bucket being shown;

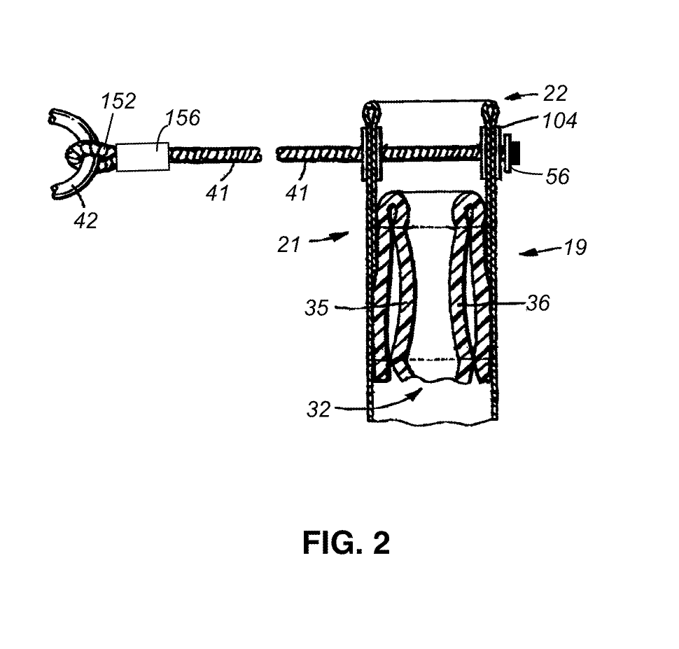

FIG. 2 is a simplified fragmented longitudinal section through a free end portion of the dump valve shown in the retracted position, with sealing lip portions thereof shown spaced apart for clarity and one purse line and associated structure;

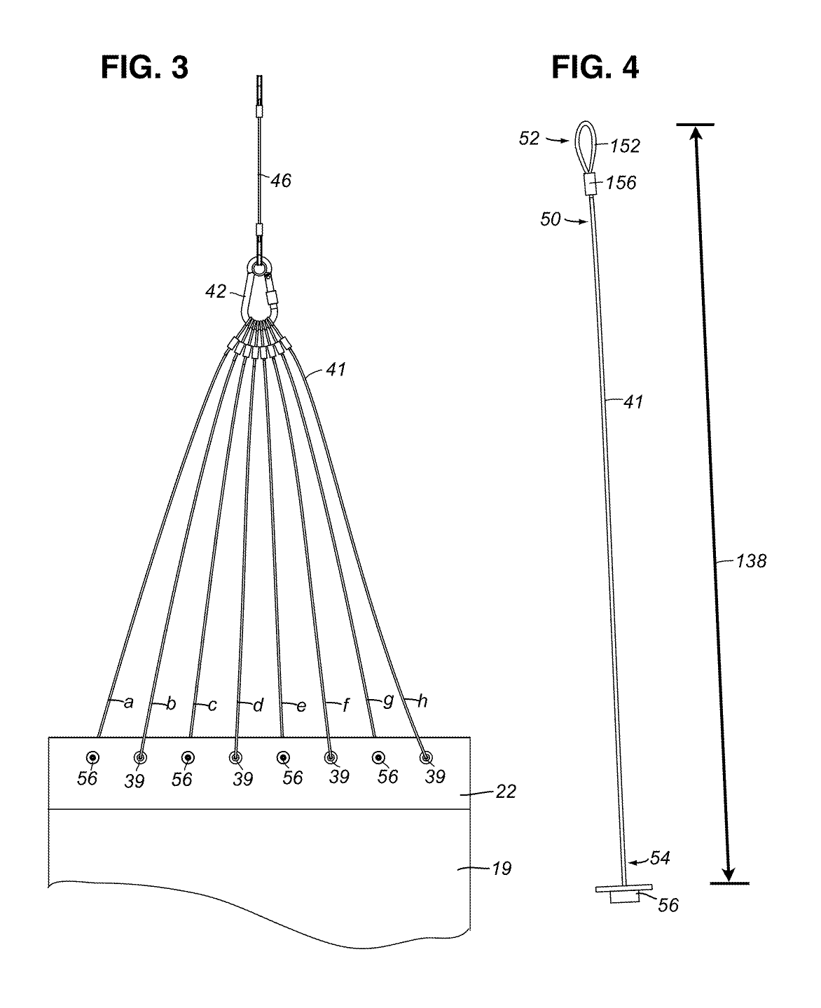

FIG. 3 is a close up view of the discharge port on the dump valve, the purse lines and the releasable connector clip;

FIG. 4 is a side view of a purse line; and

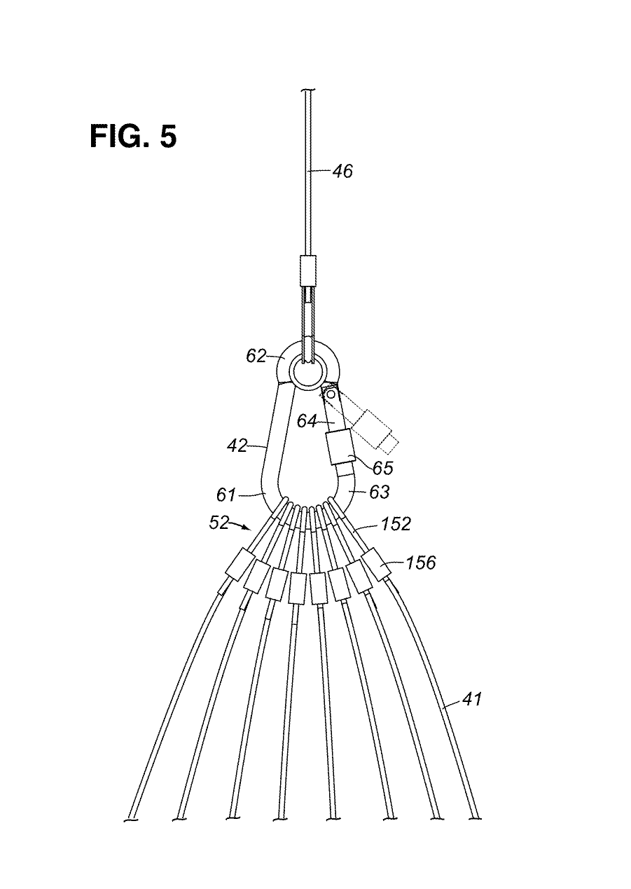

FIG. 5 is a close up view of the releasable connector clip and the connector ends of the purse lines, the connector clip being shown in a closed configuration in full outline and in an open configuration in broken outline.

### DETAILED DESCRIPTION

A fire fighting bucket 10 according to the invention bears many similarities to the earlier fire fighting buckets as disclosed in the aforementioned U.S. Pat. Nos. 4,474,245, 4,576,237, and 5,560,429, the disclosures of which are incorporated herein by reference. A brief description of the bucket follows, and details of prior art aspects can be found from the above references. Referring to FIGS. 1 and 2, the bucket 10 has an open bucket body 12 made of a tough pliable material, for example a vinyl impregnated woven synthetic fabric, and has an open upper rim 14 to facilitate filling from an open body of water, i.e. by dipping into the water. The body has a side wall 15 extending downwardly from the rim and a bottom 16 cooperating with the side wall and defining an opening. A tubular extension 19 made of pliable material is shown in a retracted position extending upwardly into the bucket from the opening in the bottom, and has a free end portion 21 formed with a discharge port 22 to serve as a dump valve. In FIG. 1, the tubular extension is shown fragmented in full outline in the retracted or raised position, and is also partially shown in broken outline in an extended or lowered position 19.1 and 19.2 extending downwardly from the bucket with the dump valve opened to permit discharge of water from the bucket.

The bucket 10 also includes a harness 23 for suspending the bucket from an aircraft (not shown), the harness comprising a control mechanism such as control head 25 which also serves as a connector for connecting to the aircraft, and a plurality of first flexible tension links 27 e.g. support cables, connected to the connector 25. The control head functions similarly to that disclosed in the patents and in particular has a spring-loaded reel, a trip mechanism for holding and releasing the reel, and controls for remote operation thereof, none of which is shown herein. The harness 23 also includes a plurality of support cables or flexible fabric straps 30 disposed in a zig-zag fashion around and extending upwardly from the upper rim 14 to connect with the plurality of cables or flexible tension links 27. One portion of the rim has a plurality of link chains 31, similarly connected in a zig-zag fashion to the rim as the tension links 27, to weight one side of the bucket to unbalance the bucket so as to facilitate filling as the bucket is dipped in a body of water.

The discharge port 22 has a sealing lip 32 that extends circumferentially around the inside of the tubular extension and defines two opposite sealing lip portions 35 and 36 (FIG. 2 only) that are brought into sealing engagement with each other for minimizing water leakage from the tubular extension. The tubular extension has a plurality of openings 39, which cooperate with a plurality of tension lines such as purse lines 41 extending downwardly from a releasable connector such as connector clip 42. The connector clip 42 is connected to a trip line 46, which is connected to a spring-loaded reel within the control head 25. Accordingly, the releasable connector is connected to the control mechanism. The spring-loaded reel is actuated by solenoid controlled linkages to permit the reel to rotate quickly to rapidly slacken the reel line and the trip line when the bucket is loaded with water so as to discharge the load, and to automatically rewind the reel line to return the tubular extension to the raised position immediately after the discharge. Operation of the dump valve is described in detail in the above-referenced U.S. patents.

The purse lines of the prior art are typically identical in composition, and a typical purse line is described as follows. Each purse line passes through a pair of aligned openings 39 in the grommets 104 which are but adjacent the two opposite lip portions 35 and 36 as shown. Thus, each opening is associated with a respective lip portion. The typical prior art purse line has an outer end on which is tied a knot that prevents the outer end from passing through the grommet and an inner end that is tied to a riser ring, which in turn is supported by the trip line 46. The end knot is typically a figure-of-eight knot tied adjacent the end of the line with a washer fitted between the grommet 104 and the knot. The inner end of the purse line is secured to the ring with a suitable knot, usually provided with several half-hitches to prevent inadvertent undoing of the knot. The length of the purse lines are individually and manually adjusted to ensure that, when the valve is withdrawn into the bucket, the sealing lip portions 35 and 36 are drawn tightly and evenly into engagement with each other, with oppositely facing terminal edges being generally coplanar with each other.

Purse lines tend to wear and must be replaced periodically. In the prior art, during the installation of the purse lines, each line is tied to the riser ring manually. The free end is threaded through the appropriate pair of aligned openings 39 in the grommets 104. A washer was fitted onto the replacement line and a knot is tied on the end for preventing the end of the line form passing through the washer. The functional length (or tie length) of the line, namely the distance from the washer to the top side of the lower section of the riser ring, is adjusted manually by loosening and re-tying the knot at either end at varying locations until the desired tie length is achieved. The tie length of some purse line varies from the tie length of others due to the varying distance between each pair of aligned grommet 104 to the riser ring.

Referring to FIGS. 2-5, there are shown simplified views of the improved purse lines and releasable connecter clip of the present invention. The purse lines 41 in accordance with the present invention are removably connected to a releasable connector clip 42 and to aligned openings on the valve such as grommets 104. The releasable connector clip 42 is connected to trip line 46 that is connected to the control mechanism, thus the connector clip is connected to the control mechanism.

The discharge port 22, the tension or purse lines 41 and the releasable connector clip 42 are shown in close up views in FIGS. 2-5. Each tension or purse line 41 of the present invention has a factory pre-set, fixed functional length 138 and includes a first end or stop end 54 having a pre-formed end-stop 56 that prevents the stop end 54 from passing through an opening 39 such as grommet 104, and a second end or connector end 50 having a pre-formed connector portion 52 for removably connecting to the releasable connector clip 42. The term “pre-formed” means that the structure of the connector portion 52 that enables it to connect to the releasable connector 42, and the structure of the end-stop 56 that prevents the stop end 54 from passing through an opening 39, is completed during manufacture of the tension line 41. As a result, the length of a tension line between these structures is factory pre-set. The connector portion 52 preferably defines a void through which the connector clip 42 is inserted, for example as it is illustrated in FIG. 4 as a loop 152 pre-formed in the line by virtue of the terminal end of the line being secured to the line using a swaged metal clamp 156. However, many alternative devices and methods are contemplated as being able to provide a pre-formed connector portion 52, including but not limited to other preformed loops, rings, and the like, that are connected to the line 41 at the connector end 50, provided they allow for the connecting of the purse line 41 to the valve. Hence the connector portion 52 such as loop 152 and the clamp 156 are sized to be threaded through the aligned openings in the valve, and then connected to the connector clip 42.

The releasable connector 42 in the present invention enables the easy placement and removal of the connector portions 52 of the tension lines 41 during replacement and installation of the tension lines. In the illustrated embodiment, the releasable connector clip 42 comprises a spring clip 61, having an eye 62 for direct or indirect connection to trip line 46, a hook portion 63 for receiving the connector portions 52, a partially threaded hinged gate 64 that opens and closes the hook portion 63, and a lock nut 65 received on the threads of the gate 64 that cooperates with the hook portion for locking the gate in a closed position. Spring clips such as this are known in the art. While the aforementioned is described and illustrated, other releasable connectors are contemplated by the present invention and may be used to releasably connect the purse lines 41.

Each purse line 41 of the present invention has a factory pre-set and fixed functional length 138 that is determined by the size of fire fighting bucket on which it is intended to be used, and in some embodiments, by its intended location on the discharge port 22 on the valve 19. The functional length 138 in the illustrated embodiment is shown between a point on the end stop 56 that abuts an opening 39 and the point on the loop 152 that engages the connector clip 42. Hence the functional length 138 of a tension line or purse line 41 is the length between the point on the connector portion 52 that engages the releasable connector 42 and the point on the stop end 54 that abuts an opening 39. In the illustrated embodiment, eight purse lines 41 are shown and are labeled with the letters (a)-(h). Purse lines (a) and (h) are the outer lines and are typically of the same length. Similarly, lines (b) and (g) correspond, lines (c) and (f) correspond, and lines (d) and (e) correspond. The line pairs may have differing functional lengths depending on the specifications that have been found to produce the best sealing action in the valve. On the prior art style buckets as in the aforementioned patents, it has been found that having lines (a) and (h) shorter than the other lines (hence under more tension) produces a better seal in the valve. In some embodiments of the bucket 10, the size of the discharge port may be such that the middle lines may be of the same length while the outer lines may be shorter, or all of the lines may be the same length. The important aspect is that each purse line is preset to a functional length that has been determined to provide optimal sealing of a particular valve design based on the purse lines' selected location on the valve. The purse lines 41 may also be coded by indicia, such as colors, numbers, letters, and the like, in corresponding sets to provide a user with a quick visual reference as to their intended location.

In the illustrated embodiment, each of the purse lines 41 is provided with a loop 152 as the connector portion 52 by means of a swaged metal clip 156 that binds the line portions together. The end stop 56 of each purse line is also a swaged metal piece that binds onto the end of the line. However, alternate configurations of connector portions 52 and end stops 56 may be used and are within the scope of the present invention.

In the illustrated configuration, the connector end 50 of the purse lines is dimensioned to be able to pass through the openings 39 in the grommets 104, but the stop end 56 is larger than the openings 39 to prevent the stop end form passing through the grommets.

To install the purse lines 41 of the present invention, firstly if there is a conventional riser ring present, it would be replaced by a releasable connector such as connector clip 42. The conventional purse lines are removed. The purse lines 41 are installed by passing each line—connector end 50 first—through the openings 39 of an aligned pair of grommets 104 until the end stop 56 abuts a grommet, and then passing the connector portion 52 onto the connector clip 42. Once all of the connector portions are on the connector clip, the clip may be secured closed, such as by the lock nut 65, to prevent the purse lines from inadvertently coming off the connector clip. Removal of the purse lines 41 is achieved by removing each connector portion 52 from the connector clip 42, and then pulling on the end stop 56 to remove the line from the grommets.

Depending on the size of the valve 19 on the bucket 10, the purse lines 41 may be required to be installed in a particular order based on each purse line's preset functional length relative to the others. For example, the lines may be in sequence as illustrated from (a) to (h) in FIG. 3. Preferably, if the order of the lines is important, then the lines are coded by some indicia to enable a user to quickly determine the correct installation sequence. For example, the lines may be coded by color, number, letter, a combination of these, or by some other visual means.

In some embodiments, the present invention may comprise a retrofit kit that includes the parts required to replace the conventional riser ring with a releasable connector 42, and a plurality of purse lines 41 of which each has a preset functional length tailored to its intended location on a particular design of valve for which it is intended, and each is adapted to be quickly and removably installed on the valve and on the releasable connector 42.

Advantageously, with the functional length of the purse lines 41 being preset, the valve of the firefighting bucket will seal properly and consistently after a replacement of the purse strings. And the releasable connector allows for quick installation and removal of the purse lines of the present invention.

It should be noted that prior to the present invention, from the time of the first of these kinds of fire fighting buckets (as in U.S. Pat. No. 4,474,245) in the early 1980's to the present, the adjustment for setting the functional length of the purse strings on thousands of such buckets has been done manually by tying and re-tying knots at various locations on the line, as described in the referenced U.S. patents. Not until the present invention have the problems associated with such prior art methods and apparatus been addressed.

While the above description and illustrations constitute preferred or alternate embodiments of the present invention, it will be appreciated that numerous variations may be made without departing from the scope of the invention. It is intended that the invention be construed as including all such modifications and alterations.

What is claimed is:

1. A collapsible fire fighting bucket assembly to be suspended from an aircraft comprising:
(a) a harness for suspending the bucket from the aircraft;
(b) an open bucket body of pliable material having an open upper rim to facilitate filling from an open body of water, a side wall extending downwardly from the rim and a bottom cooperating with the side wall and having an opening;
(c) a tubular extension made of pliable material and extending from the opening in the bottom, the tubular extension having a free end formed with a discharge port to serve as a dump valve, the discharge port having a sealing lip of resilient sealing material which forms two opposite lip portions that are brought into sealing engagement with each other for minimizing water leakage from the tubular extension, the tubular extension having a plurality of aligned openings, each opening being associated with a respective lip portion of the sealing lip for bringing the lip portions into sealing engagement;
(d) a plurality of tension lines, each having a first end with a pre-formed end stop and a second end with a pre-formed connector portion, each tension line passing from the end stop, through a pair of aligned openings in the lip to the second end;
(e) a control mechanism to which the connector portion of the tension lines are releasably connected for moving the tubular extension between a raised position in which the free end thereof extends upwardly from the bottom with the discharge port positioned below a full water level in the bucket and a lowered position in which the free end of the tubular extension extends downwardly from the bottom of the bucket for dumping the water;
(f) wherein each tension line has a preset length between the end stop and the connector portion.

2. A fire fighting bucket as claimed in claim 1, wherein the control mechanism includes a releasable connector clip and the connector portion defines a void through which the connector clip is inserted, thereby achieving the releasable connection between the control mechanism and the tension lines.

3. A fire fighting bucket as claimed in claim 2, wherein the connector portion comprises a loop portion at the second end for releasably connecting to the releasable connector clip.

4. A fire fighting bucket as claimed in claim 1, wherein the preset length of each tension line is based on the location of said tension line on the tubular extension.

5. A fire fighting bucket as claimed in claim 2, wherein the preset length of each tension line is based on the location of said tension line on the tubular extension.

6. A fire fighting bucket as claimed in claim 4, wherein the preset length of the tension lines that are located towards the sides of the tubular extension are shorter than the preset length of the tensions lines that are located towards the centre of the tubular extension such that the outer tension lines are under greater tension than the inner tension lines.

7. A fire fighting bucket as claimed in claim 5, wherein the preset length of the tension lines that are located towards the sides of the tubular extension are shorter than the preset length of the tensions lines that are located towards the centre of the tubular extension such that the outer tension lines are under greater tension than the inner tension lines.

8. A fire fighting bucket as claimed in claim 6, wherein the tension lines include indicia that varies based on the preset length of the tension lines such that tension lines of the same preset length have common indicia and tension lines of different preset lengths having differing indicia.

9. A fire fighting bucket as claimed in claim 7, wherein the tension lines include indicia that varies based on the preset length of the tension lines such that tension lines of the same preset length have common indicia and tension lines of different preset lengths having differing indicia.

10. A fire fighting bucket as claimed in claim 9, wherein the indicia comprises color.

11. In a fire fighting bucket assembly in which a tubular extension made of pliable material extends from an opening in the bottom of the bucket and has a free end formed with a discharge port to serve as a dump valve, and in which the discharge port has a sealing lip of resilient sealing material which forms two opposite lip portions that are brought into sealing engagement with each other for minimizing water leakage from the tubular extension, and in which the tubular extension has a plurality of aligned openings, each opening being associated with a respective lip portion of the sealing lip for bringing the lip portions into sealing engagement, and in which a plurality of purse lines pass through pairs of aligned openings and are connected to a control mechanism for raising and lowering the tubular extension, an improved valve control system comprising:
(a) a releasable connector clip connected to the control mechanism;
(b) plurality of purse lines, each having a first end with a pre-formed end stop for preventing the first end from passing through the opening and a second end having a pre-formed loop portion for connecting onto the releasable connector clip, wherein each purse line has a preset length between the end stop and the loop portion.

12. A valve control system as claimed in claim 11, wherein the preset length of each purse line is based on the location of said purse line on the tubular extension.

13. A valve control system as claimed in claim 12, wherein the preset length of the purse lines that are located towards the sides of the tubular extension are shorter than the preset length of the purse lines that are located towards the centre of the tubular extension such that the outer purse lines are under greater tension than the inner purse lines.

14. A valve control system as claimed in claim 13, wherein the purse lines include indicia that varies based on the preset length of the purse lines such that purse lines of the same preset length have common indicia and purse lines of different preset lengths having differing indicia.

15. A valve control system as claimed in claim 14, wherein the indicia comprises color.

16. In a fire fighting bucket assembly in which a tubular extension made of pliable material extends from an opening in the bottom of the bucket and has a free end formed with a discharge port to serve as a dump valve, and in which the discharge port has a sealing lip of resilient sealing material which forms two opposite lip portions that are brought into sealing engagement with each other for minimizing water leakage from the tubular extension, and in which the tubular extension has a plurality of aligned openings, each opening being associated with a respective lip portion of the sealing lip for bringing the lip portions into sealing engagement, and in which a plurality of purse lines pass through pairs of aligned openings and are connected to a control mechanism for raising and lowering the tubular extension, an improved method of replacing worn purse lines comprising:
(a) disconnecting the worn purse lines form the control mechanism and removing the worn purse lines from the aligned openings;
(b) providing a releasable connector clip and connecting the clip to the control mechanism;
(c) providing a plurality of replacement purse lines, each having a first end with a pre-formed end stop and a second end having a pre-formed loop portion, and each having a preset length between the end stop and the loop portion;
(d) threading each purse line through a pair of aligned openings, starting from the second end to the first end until the end stop abuts the opening to prevent the first end from passing through; and
(e) connecting the loop portion of each purse line onto the releasable connector clip.

17. A method as claimed in claim 16, wherein the purse lines provided in step (c) vary in their preset length such that the purse lines located towards the sides of the tubular extension are shorter than the purse lines located towards the centre of the tubular extension.

18. A method as claimed in claim 17, wherein step (e) comprises connecting the loop portions of the purse lines onto the clip member in the same sequence in which the purse lines are located on the tubular member.
